(19) United States
(12) Patent Application Publication
(10) Pub. No.: US 2025/0164686 A1
(43) Pub. Date: May 22, 2025

(54) HIGH-BRIGHTNESS DISPLAY SCREEN

(71) Applicant: NEWRGY LIMITED, AURORA, CO (US)

(72) Inventors: JIYUAN WEI, SHENZHEN (CN); FENFANG LI, SHENZHEN (CN)

(21) Appl. No.: 18/764,555

(22) Filed: Jul. 5, 2024

(30) Foreign Application Priority Data
Nov. 16, 2023 (CN) 202323092013.X

(51) Int. Cl. F21V 8/00; G02F 1/13357

(52) U.S. Cl. CPC G02B 6/0053; G02B 6/0031; G02B 6/0073; G02F 1/1336

(57) ABSTRACT

A high-brightness display screen is provided. The high-brightness display screen includes a light guide plate, a backlight source, a first light reflective film, a light-transmitting film material, a liquid crystal glass, a second light reflective film, and a housing. The backlight source includes a light emitting surface facing a side surface of the light guide plate. The first light reflective film is disposed at a rear surface of the light guide plate. The light-transmitting film material is disposed on a surface of the light guide plate. The liquid crystal glass is disposed above the light transmitting film material. The second light reflective film is disposed between the liquid crystal glass and the light-transmitting film material, is adjacent to the backlight source, is disposed along edges of a surface of the light-transmitting film material, and not covers an effective display area.

### TECHNICAL FIELD

The present disclosure relates to a technical field of display screen devices, and in particular to a high-brightness display screen.

### BACKGROUND

Brightness of display screens is one of key parameters to determine whether the display screens are capable of clearly displaying corresponding contents, when surrounding brightness is high, the brightness of the display screens needs to be correspondingly increased, so that users may more clearly see corresponding displaying contents.

In the prior art, the display screens each is provided a backlighting panel corresponding to an effective display area thereof or slightly larger than the effective display area thereof, the backlighting panel serves as a backlight brightness adjustment module, such display screens are thicker, thereby causing relatively high power consumption. As the display screen technology develops, the display screens are improved to each provide at least one backlight source at a side edge thereof, an area of each at least one backlight source is much smaller than a conventional backlighting panel, and the display screens each uses a corresponding light guide plate to guide a light of a corresponding at least one backlight source to a corresponding display module, in this way, power consumption of such display screens is reduced, and thicknesses of such display screens are further optimized. However, since each at least one backlight source is provided at the side edge, the display screens are prone to light shadow and light leakage, which may affect user experience.

### SUMMARY

In view of above problems, the present disclosure provides a high-brightness display screen, aiming to solving technical problems proposed in the background.

In order to achieves above aims, the present disclosure provides a first embodiment of the high-brightness display screen.

The present disclosure provides the high-brightness display screen, including a light guide plate, a backlight source, a first light reflective film, a light-transmitting film material, a liquid crystal glass, a second light reflective film, and a housing. The backlight source includes a light emitting surface facing a side surface of the light guide plate. The first light reflective film is disposed at a rear surface of the light guide plate. The light-transmitting film material is disposed on a surface of the light guide plate. The liquid crystal glass is disposed above the light transmitting film material. The second light reflective film is disposed between the liquid crystal glass and the light-transmitting film material, is adjacent to the backlight source, is disposed along edges of a surface of the light-transmitting film material, and not covers an effective display area. The light guide plate, the backlight source, the light-transmitting film material, the liquid crystal glass, and the second light reflective film are disposed in the housing.

Furthermore, the backlight source includes at least one LED light strip.

Furthermore, the light-transmitting film material includes a lower brightness enhancement film, an upper brightness enhancement film, and a dual brightness enhancement film (DBEF). The lower brightness enhancement film is disposed on the surface of the light guide plate, the upper brightness enhancement film is disposed on a surface of the lower brightness enhancement film, and the DBEF is disposed on a surface of the upper brightness enhancement film. The second light reflective film is disposed at an edge of a surface of the DBEF.

Furthermore, the housing includes a rear plate frame, a middle frame, and an outer housing. The middle frame and an edge of the rear plate frame are enclosed to form a connection area. The backlight source is disposed in the connection area. The middle frame and the outer housing are connected to clamp edges of the liquid crystal glass, and the middle frame separates the second light reflective film from the liquid crystal glass.

Furthermore, the rear plate frame includes a rear plate portion and a bottom frame portion. The first light reflective film is disposed on a surface of the rear plate portion, The bottom frame portion includes a heat dissipation air duct corresponding to the backlight source.

The present disclosure further provides a second embodiment of the high-brightness display screen, including the light guide plate, the backlight source, the first light reflective film, the liquid crystal glass, the second light reflective film, and the housing. The backlight source includes the light emitting surface facing the side surface of the light guide plate. The first light reflective film is disposed at the rear surface of the light guide plate. The liquid crystal glass is disposed above the light guide plate. The second light reflective film is disposed at an edge of the surface of the light guide plate, a side edge of the second light reflective film facing the backlight source is adjacent to the backlight source. The light guide plate, the backlight source, the liquid crystal glass, and the second light reflective film are disposed in the housing.

Furthermore, the high-brightness display screen further includes a brightness enhancement module, the brightness enhancement module is disposed between the surface of the light guide plate and a rear surface of the liquid crystal glass. A first side edge of the second light reflective film is the side edge of the second light reflective film facing the backlight source and is adjacent to the backlight source, and a second side edge of the second light reflective film is adjacent to a side surface of the brightness enhancement module.

Furthermore, the brightness enhancement module includes a diffusion film, the lower brightness enhancement film, the upper brightness enhancement film, and the DBEF. The diffusion film is disposed on the surface of the light guide plate, the lower brightness enhancement film is disposed on a surface of the diffusion film, the upper brightness enhancement film is disposed on the surface of the lower brightness enhancement film, and the DBEF is disposed on the surface of the upper brightness enhancement film.

Furthermore, the second side edge of the second light reflective film is adjacent to a side surface of the diffusion film.

Compared with the prior art, the high-brightness display screen of the present disclosure is provided with the second reflectively film which is capable of reflecting a missed light of the backlight source and a light resulting light shadow back to the light guide plate for reuse, thereby increasing a utilization rate of lights to increase brightness. The high-brightness display screen of the present disclosure is low in power consumption and the backlight source thereof has a longer service life.

### BRIEF DESCRIPTION OF DRAWINGS

FIG. 1 is a partial cross-section schematic diagram of a first embodiment of a high-brightness display screen of the present disclosure.

FIG. 2 is a partial cross-section schematic diagram of a second embodiment of the high-brightness display screen of the present disclosure.

Reference numerals in the drawings: 1. light guide plate; 2. backlight source; 3. first light reflective film; 4. liquid crystal glass; 5. second light reflective film; 610. lower brightness enhancement film; 620. upper brightness enhancement film; 630. dual brightness enhancement film (DBEF); 640. diffusion film; 711. rear plate portion; 712. bottom frame portion; 7121. heat dissipation air duct; 715. connection area; 720. middle frame; 730. outer housing.

### DETAILED DESCRIPTION OF EMBODIMENTS

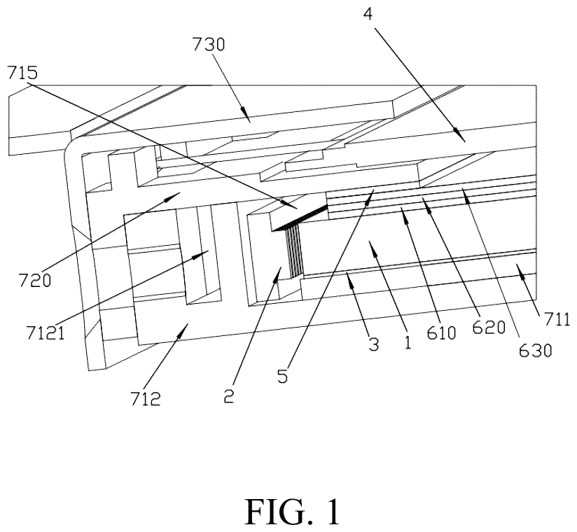

Please refer to FIG. 1, the present disclosure provides a first embodiment of a high-brightness display screen, including a light guide plate 1, a backlight source 2, a first light reflective film 3, a light-transmitting film material, a liquid crystal glass 4, a second light reflective film 5, and a housing. The backlight source 2 includes a light emitting surface facing a side surface of the light guide plate 1. The first light reflective film 3 is disposed at a rear surface of the light guide plate 1. The light-transmitting film material is disposed on a surface of the light guide plate 1. The liquid crystal glass 4 is disposed above the light transmitting film material. The second light reflective film 5 is disposed between the liquid crystal glass 4 and the light-transmitting film material, is adjacent to the backlight source 2, is disposed along edges of a surface of the light-transmitting film material, and not covers an effective display area. The light guide plate 1, the backlight source 2, the light-transmitting film material, the liquid crystal glass 4, and the second light reflective film 5 are disposed in the housing.

According to the high-brightness display screen of the present disclosure, the second light reflective film 5 is disposed between the liquid crystal glass 4 and the light-transmitting film material, one side edge of the second light reflective film 5 is disposed adjacent to the backlight source 2, and the second light reflective film 5 is further disposed along the edges of the surface of the light-transmitting film material, in this way, a light emitted by the backlight source 2 after passing through the light guide plate 1 and the light-transmitting film material and before reaching a boundary between the liquid crystal glass 4 and the effective display area is capable of being blocked and reflected by the second reflectively film 5, so as to be reflected into the light guide plate 1. Meanwhile, a light in the backlight source 2 that does not pass through the light guide plate 1 and the light-transmitting film material and directly goes toward the boundary between the liquid crystal glass 4 and the effective display area is also blocked and reflected by the second reflectively film 5, so as to be reflected into the light guide plate 1. Through additionally proving the second reflectively film 5 in the high-brightness display screen and arranging the second reflectively film 5 as foregoing, a light shadow generated by projecting the light emitted by the backlight source 2 onto the light guide plate 1, the light-transmitting film material, and the liquid crystal glass 4 is block, and light leakage is further avoided.

The second reflectively film 5 reflects a missed light of the backlight source 2 and a light resulting light shadow back to the light guide plate 1 for reuse, thereby increasing a utilization rate of lights to increase brightness. In some comparative tests, compared the high-brightness display panel of the present disclosure with a conventional display screen, on condition that the backlight source 2 has the same output power, final display brightness of the effective display area is increased by 30%. Therefore, the high-brightness display screen of the present disclosure is lower in power consumption and the backlight source thereof has a longer service life.

In some embodiments, two sets of the backlight source 2 are provided, the second light reflective film 5 is disposed on the surface of the light-transmitting film material and is disposed along an edge of the surface of the light-transmitting film material. The two sets of the backlight source 2 are respectively disposed at two side surfaces of the light guide plate 1, and two light emitting portions of the two sets of the backlight source 2 are disposed opposite to each other.

In an optional embodiment, the backlight source 2 includes at least one LED light strip.

In some embodiments, the light-transmitting film material includes a lower brightness enhancement film 610, an upper brightness enhancement film 620, and a dual brightness enhancement film (DBEF) 630. The lower brightness enhancement film 610 is disposed on the surface of the light guide plate 1, the upper brightness enhancement film 620 is disposed on a surface of the lower brightness enhancement film 610, and the DBEF 630 is disposed on a surface of the upper brightness enhancement film 620. The second light reflective film 5 is disposed at an edge of a surface of the DBEF 630.

Please refer to FIG. 1, the housing includes a rear plate frame, a middle frame 720, and an outer housing 730. The middle frame 720 and an edge of the rear plate frame are enclosed to form a connection area 715. The backlight source 2 is disposed in the connection area 715. The middle frame 720 and the outer housing 730 are connected to clamp edges of the liquid crystal glass 4, and the middle frame 720 separates the second light reflective film 5 from the liquid crystal glass 4.

The connection area 715 accommodates an edge of the light-transmitting film material, an edge of the light guide plate 1, and the second light reflective film 5. The middle frame 720 separates the second light reflective film 5 from the liquid crystal glass 4, thereby avoiding a problem that the missed light of the backlight source 2 passes through the liquid crystal glass 2 to enter the effective display area to affect the user experience.

Please refer to FIG. 1, the rear plate frame includes a rear plate portion 711 and a bottom frame portion 712. The first light reflective film 3 is disposed on a surface of the rear plate portion 711, The bottom frame portion 712 includes a heat dissipation air duct 7121 corresponding to the backlight source 2.

When an air blowing component is disposed in the high-brightness display screen and is in butt joint with the heat dissipation air duct 7121, a heat dissipation effect is achieved for the backlight source 2, thereby prolonging a service life of the backlight source 2.

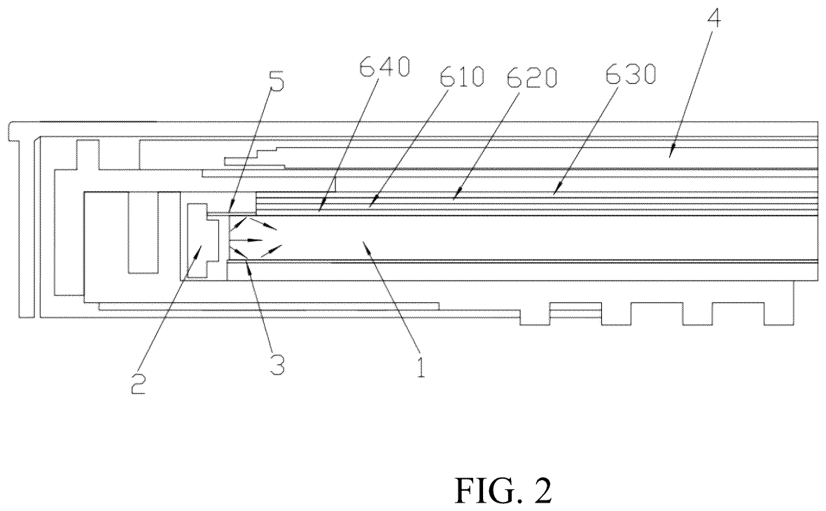

Please refer to FIG. 2, the present disclosure provides a second embodiment of the high-brightness display screen, including the light guide plate 1, the backlight source 2, the first light reflective film 3, a brightness enhancement module, the liquid crystal glass 4, the second light reflective film 5, and the housing. The backlight source 2 includes the light emitting surface facing the side surface of the light guide plate 1. The first light reflective film 3 is disposed at the rear surface of the light guide plate 1. The brightness enhancement module is disposed on the surface of the light guide plate 1. The liquid crystal glass 4 is disposed above the light guide plate 1. The second light reflective film 5 is disposed at an edge of the surface of the light guide plate 1, a side edge of the second light reflective film 5 facing the backlight source 2 is adjacent to the backlight source 2. The light guide plate 1, the backlight source 2, the brightness enhancement module, the liquid crystal glass 4, and the second light reflective film 5 are disposed in the housing.

The second light reflective film 5 is disposed at the edge of the surface of the light guide plate 1, and the side edge of the second light reflective film 5 facing the backlight source 2 is adjacent to the backlight source 2. The side edge of the second light reflective film 5 facing the backlight source 2 is configured to block and further reflect the missed light of the backlight source 2, thereby avoiding the light emitted by the backlight source 2 from directly going toward the liquid crystal glass 4, in this way, the missed light of the backlight source 2 and the light resulting the light shadow are capable of being reflated back to the light guide plate 1 for reuse, so as to increase the utilization rate of the lights to increase the brightness. In some comparative tests, compared the high-brightness display panel of the present disclosure with the conventional display screen, on the condition that the backlight source 2 has the same output power, the final display brightness of the effective display area is increased by 30%. Therefore, the high-brightness display screen of the present disclosure is lower in the power consumption and the backlight source thereof has the longer service life.

The side edge of the second light reflective film 5 facing the backlight source 2 is connected to an outer portion of the backlight source 2, and is configured to block a light emitted by the backlight source 2 to the side.

Please refer to FIG. 2, the brightness enhancement module is disposed between the surface of the light guide plate 1 and a rear surface of the liquid crystal glass 4. A first side edge of the second light reflective film 5 is the side edge of the second light reflective film 5 facing the backlight source 2 and is adjacent to the backlight source 2, and a second side edge of the second light reflective film 5 is adjacent to a side surface of the brightness enhancement module.

A portion of the second light reflective film 5 that is disposed at the edge of the surface of the light guide plate 1 and is adjacent to the brightness enhancement module is configured to block and further reflect a light of the backlight source 2 that passes through the light guide plate 1 but does not emit from a side portion of the brightness enhancement module, so as to avoid the light emitted by the backlight source 2 from directly going toward the liquid crystal glass 4. The missed light of the backlight source 2 and the light resulting the light shadow are capable of being reflated back to the light guide plate 1 for reuse, so as to increase the utilization rate of the lights to increase the brightness.

Please refer to FIG. 2, the brightness enhancement module includes a diffusion film 640, the lower brightness enhancement film 610, the upper brightness enhancement film 620, and the DBEF 630. The diffusion film 640 is disposed on the surface of the light guide plate 1, the lower brightness enhancement film 610 is disposed on a surface of the diffusion film 640, the upper brightness enhancement film 620 is disposed on the surface of the lower brightness enhancement film 610, and the DBEF 630 is disposed on the surface of the upper brightness enhancement film 620.

In some embodiments, the DBEF 630 is 3M™ DBEF.

Please refer to FIG. 2, the second side edge of the second light reflective film 5 is adjacent to a side surface of the diffusion film 640.

A thickness of the second light reflective film 5 does not need to be too thick and is configured to be flush with the diffusion film 640, so as to better connect the second side edge of the second reflective film 5 to the side surface of the diffusion film 640.

1. A high-brightness display screen, comprising:
a light guide plate;
a backlight source, having a light emitting surface facing a side surface of the light guide plate;
a first light reflective film, disposed at a rear surface of the light guide plate;
a light-transmitting film material, disposed on a surface of the light guide plate;
a liquid crystal glass, disposed above the light transmitting film material;
a second light reflective film, disposed between the liquid crystal glass and the light-transmitting film material, adjacent to the backlight source, attached to a surface of the light-transmitting film material and extending along edges of the surface of the light-transmitting film material, and not covering an effective display area; and
a housing;
wherein the light guide plate, the backlight source, the light-transmitting film material, the liquid crystal glass, and the second light reflective film are disposed in the housing.

2. The high-brightness display screen according to claim 1, wherein the backlight source comprises at least one LED light strip.

3. The high-brightness display screen according to claim 1, wherein the light-transmitting film material comprises a lower brightness enhancement film, an upper brightness enhancement film, and a dual brightness enhancement film (DBEF); the lower brightness enhancement film is disposed on the surface of the light guide plate, the upper brightness enhancement film is disposed on a surface of the lower brightness enhancement film, and the DBEF is disposed on a surface of the upper brightness enhancement film; the second light reflective film is disposed at an edge of a surface of the DBEF.

4. The high-brightness display screen according to claim 1, wherein the housing comprises a rear plate frame, a middle frame, and an outer housing; the middle frame and an edge of the rear plate frame are enclosed to form a connection area; the backlight source is disposed in the connection area; the middle frame and the outer housing are connected to clamp edges of the liquid crystal glass, and the middle frame separates the second light reflective film from the liquid crystal glass.

5. The high-brightness display screen according to claim 4, wherein the rear plate frame comprises a rear plate portion and a bottom frame portion; the first light reflective film is disposed on a surface of the rear plate portion; and the bottom frame portion comprises a heat dissipation air duct corresponding to the backlight source.

6. A high-brightness display screen, comprising:
a light guide plate;
a backlight source, having a light emitting surface facing a side surface of the light guide plate;
a first light reflective film, disposed at a rear surface of the light guide plate;
a liquid crystal glass, disposed above the light guide plate;
a second light reflective film, attached to an edge of a first surface of the light guide plate, wherein the first surface is a surface of the light guide plate facing towards the liquid crystal glass; and
a housing;
wherein a side edge of the second light reflective film facing the backlight source is adjacent to the backlight source; and the light guide plate, the backlight source, the liquid crystal glass, and the second light reflective film are disposed in the housing.

7. The high-brightness display screen according to claim 6, wherein the high-brightness display screen further comprises a brightness enhancement module, the brightness enhancement module is disposed between the first surface of the light guide plate and a rear surface of the liquid crystal glass; a first side edge of the second light reflective film is the side edge of the second light reflective film facing the backlight source and is adjacent to the backlight source, and a second side edge of the second light reflective film is adjacent to a side surface of the brightness enhancement module.

8. The high-brightness display screen according to claim 7, wherein the brightness enhancement module comprises a diffusion film, a lower brightness enhancement film, an upper brightness enhancement film, and a dual brightness enhancement film (DBEF); the diffusion film is disposed on the first surface of the light guide plate, the lower brightness enhancement film is disposed on a surface of the diffusion film, the upper brightness enhancement film is disposed on a surface of the lower brightness enhancement film, and the DBEF is disposed on a surface of the upper brightness enhancement film.

9. The high-brightness display screen according to claim 8, wherein the second side edge of the second light reflective film is adjacent to a side surface of the diffusion film.

10. The high-brightness display screen according to claim 6, wherein the high-brightness display screen further comprises a brightness enhancement module, the first surface of the light guide plate comprises a first region and a second region, the brightness enhancement module is arranged on and cover the first region, and the second region is disposed between the first region and the side surface of the light guide plate; the second light reflective film is arranged on and covers the second region of the first surface and extends out of edges of the second region.

11. The high-brightness display screen according to claim 10, wherein, along a direction perpendicular to the first surface of the light guide plate, the second light reflective film has a first orthographic projection onto the housing, the backlight source has a second orthographic projection onto the housing; and a portion of the second orthographic projection is located inside the first orthographic projection, and another portion of the second orthographic projection is located out of the first orthographic projection.
